(19) United States
(12) Patent Application Publication
(10) Pub. No.: US 2026/0324563 A1
(43) Pub. Date: Oct. 22, 2026

(54) DENSELY PLANTED COCONUT PALM GROVE WITH INCREASED YIELD

(71) Applicant: VIRIDIS ARBOR LLC, Verona, NJ (US)

(72) Inventor: Gary E. Abeles, Verona, NJ (US)

(73) Assignee: VIRIDIS ARBOR LLC, Verona, NJ (US)

(21) Appl. No.: 19/711,268

(22) Filed: Jun. 17, 2026

Related U.S. Application Data
(63) Continuation of application No. 19/394,410, filed on Nov. 19, 2025.
Application No. 19/394,410 is a continuation-in-part of application No. PCT/US24/27032, filed on Apr. 30, 2024.
(60) Provisional application No. 63/508,391, filed on Jun. 15, 2023.

(51) Int. Cl. A01G 17/00

(52) U.S. Cl. CPC A01G 17/005

(57) ABSTRACT

A method of growing coconuts comprises selecting at least one coconut palm variety and preparing a plurality of planting locations, whereby when the planted coconut palms are mature, the leaf balls of adjacent palms alternate in height above grade and overlap each other without mutual interference, thereby increasing the number of palms per acre. Adjacent palms can be of different varieties having differing mature lengths, and/or adjacent planting locations can be excavated and/or built up so that they alternate in elevation. The palms can be configured in a “checkerboard” arrangement where leaf ball heights alternate in aligned rows and columns, or in a “hexagonal” arrangement where rows of palms of alternating leaf ball height are staggered. Palm rows of alternating height can be planted on north-south tiers at successively greater elevations, up to an apex tier, from which the tiers can descend again in elevation.

### RELATED APPLICATIONS

This application is a continuation in part of U.S. application Ser. No. 19/394,410 filed on Nov. 19, 2025. Application Ser. No. 19/394,410 is a continuation in part of International Application No. PCT/US 24/27032, filed Apr. 30, 2024. Application PCT/US 24/27032 claims the benefit of US Application No. 63/508,391, filed Jun. 15, 2023. All of these applications are herein incorporated by reference in their entirety for all purposes.

### FIELD OF THE INVENTION

The invention relates to farming of tree-based produce, and more particularly to coconut farming.

### BACKGROUND OF THE INVENTION

Coconut palms grow in sandy soil where there is ample sun and rainfall. While the roots will generally grow outwards for up to 30 feet, they tend to stay near the surface, with 80% of the roots remaining within 30-90 cm from the surface (1-3 feet), and 94% of the roots remaining within 90-150 cm from the surface, (3-5 feet). The leaves or “fronds” of coconut palms are configured as leaf “balls” that spread outward from the top of the trunk of the palm. The leaf ball can comprise a ring of substantially horizontal fronds and a “crown” extending upward to the top of the leaf ball. For taller varieties, the leaf ball occupies about the upper one third of the palm, while for shorter varieties the leaf ball occupies approximately the upper half of the palm.

For some varieties of palm, the leaf ball extends in an approximately spherical pattern to a distance of as much as 9-10 feet in all directions. For other palm varieties, the horizontal diameter of the leaf “ball” may be larger than its height. For example, the leaf ball can have a 20-foot diameter and a leaf ball height of only 5 feet, where the leaf ball height is the vertical distance from the bottom of the leaf ball to the top of the crown. The term leaf “ball” is used herein to refer to the grouping of leaves or fronds that extend from the top of the trunk, including the crown, whether or not the leaf “ball” is actually spherical.

With reference to FIG. 1, in a coconut farm, the coconut palms 100 are planted with their trunks 102 about 20 feet apart, so as to minimize interference between the 20-foot-wide leaf balls 104 of neighboring palms. However, this relatively wide spacing limits the number of palms that can be planted, and hence the number of coconuts that can be harvested, per acre of land.

What is needed, therefore, is a coconut palm grove configured to provide an increased yield of coconuts per acre of land.

### SUMMARY OF THE INVENTION

The present invention is a method of growing coconuts that provides an increased yield of coconuts per acre of land. The method includes selecting at least one variety of coconut palm to be planted, preparing planting locations in a field, and distributing and planting the coconut palms in the planting locations. In embodiments, the resulting grove of coconut palms comprises at least 30 coconut palms, and can comprise 100 or more coconut palms. It will be noted that the terms “palm,” “coconut palm,” “palm tree,” and “coconut palm tree” are used herein interchangeably to refer to a coconut palm tree.

According to the present invention, when the coconut palms are mature, the heights of their leaf balls alternate above grade, where the term “grade,” as used herein, refers to an average height of the field above sea level, and the term “alternate” means that for each given one of the leaf balls, the leaf balls of all of the adjacent palms are either higher or lower than the leaf ball of the given palm, thereby allowing the leaf balls of adjacent palms to overlap.

As used herein, the palms that are “adjacent” to a given coconut palm are the palms that form a first ring of neighboring palms around the given coconut palm within the planting arrangement. This first ring need not be circular, regular, equidistant, complete, or closed. Distances between the given coconut palm and the adjacent palms can vary. In addition, for coconut palms located along a perimeter of a grove, the first ring can include fewer palms than for coconut palms located within an interior region of the grove. The “length” of a palm refers herein to the distance from the point at which the trunk emerges from the ground to the top of the leaf ball.

The planting locations are prepared sufficiently close to each other such that the leaf balls of the adjacent, mature coconut palms overlap. Interference between adjacent leaf balls is avoided due to the differences in adjacent leaf ball heights. This allows the coconut palms to be positioned much more closely together than in conventional coconut groves in which mutual interference between leaf balls having substantially the same heights limits the density of the grove and the quantity of coconuts produced per acre.

In exemplary embodiments, the production of coconuts per acre, when planted according to the disclosed method, is more than doubled as compared to conventional coconut groves. For example, if the leaf balls are approximately 20 feet in diameter, the spacing between palms can be reduced from 20 feet to approximately 12 feet, allowing the leaf balls at the lower height to nearly touch the trunks of the adjacent palms for which the leaf balls are higher. By reducing the inter-palm spacing by nearly a factor of 2, in this example the yield of coconuts per acre is increased by nearly a factor of 3, and in some embodiments nearly a factor of 4. In similar examples, the spacing between the palms can be reduced from 20 feet to about 16 feet, resulting in a 50% increase in coconut yield per acre of land.

Embodiments provide the alternating leaf ball heights by implementing either or both of two strategies. One approach is to intersperse coconut palm varieties that grow to different heights. For example, the leaf balls of “dwarf” varieties such as Malaysian or Fiji dwarf palms will generally fit entirely beneath the leaf balls of adjacent “tall” varieties such as Solomon Islands, Rennell, or Malaysian tall palms.

The other strategy is to alternate the elevations above sea level of the individual planting locations by some combination of excavating and/or building up the ground at the planting locations. In some embodiments, all of the coconut palms are of the same variety and grow to the same length, such that the height alternation of the leaf balls results entirely from variations in the heights of the individual planting locations.

In some embodiments, all of the leaf balls are either at a first height above grade, or at a second height above grade that is lower than the first height. In these embodiments, all of the coconut palms having leaf balls at the first height are surrounded by coconut palms having leaf balls at the second height, and vice versa.

In some of these embodiments, the coconut palms are planted in rows and columns, referred to herein as a “checkerboard” arrangement, whereby each of the palms that is not at an edge of the grove and that has a leaf ball at the first height is surrounded by four adjacent palms having leaf balls at the second height, and vice versa. For example, short and tall varieties of palms can be alternated in both their rows and columns, or the heights of the planting locations beneath palms of the same variety can be alternated in both their rows and columns, by building up the ground under every other palm and/or lowering the ground beneath every other palm.

In these checkerboard embodiments, for each palm that is not at an edge of the grove, the adjacent palms will be the four nearest neighboring palms located in four orthogonal directions from the given coconut palm. In embodiments, palms grown in a checkerboard pattern and having 20-foot leaf ball diameters can be located as closely as 14 to 16 feet apart in both the rows and the columns, thereby nearly increasing the coconut yield by about 50%.

In similar embodiments, the coconut palms are planted in offset rows that form a “hexagonal” arrangement, whereby each of the palms that is not at an edge of the grove and that has a leaf ball at the first height is surrounded by three adjacent palms having leaf balls at the second height, and vice versa. In such hexagonal arrangements, the palms that are adjacent to a given palm are the nearest three palms, which are located in directions separated by 120 degrees, for example at zero degrees, 120 degrees, and 240 degrees from the given palm. In embodiments, palms planted in a hexagonal arrangement and having leaf ball diameters of 20 feet can be spaced as closely as 12 feet apart, nearly quadrupling the yield of coconuts per acre.

In addition to creating or enhancing differences in leaf ball heights, the approach of varying the heights of the planting locations above or below grade can have the benefit of avoiding interference between the roots of adjacent palms. For example, by planting every other palm in a “recessed” location that is at least five feet below the planting locations of adjacent palms, interference between the leaf balls of adjacent palms can be avoided, while at the same time causing the roots of the palms planted in the excavated locations to extend at a depth that is well below the roots of the adjacent palms.

When configured in a checkerboard or hexagonal arrangement of alternating heights, the leaf balls of palms that are not at the uppermost height will receive direct sunlight only during a limited duration near the middle of each day when the sun is approximately overhead, while receiving less light at other times of day due to being in the “shadow” of the overlapping leaf balls of adjacent palms that are at the greater heights. Nevertheless, because coconut palms are typically grown in areas that receive abundant sunlight, in embodiments the “shorter” palms will receive sufficient sunlight to be able to thrive. In fact, in embodiments the increased “shade” that results from the dense planting of palms in a checkerboard or hexagonal arrangement, according to embodiments of the present invention, can help to protect the palms having leaf balls at lower heights above grade from receiving too much sun, and thereby help them to retain water.

In still other embodiments, the planting locations are prepared on “terraces” that are created by excavating “tiers” into a hillside or similar terrain. According to this approach, the heights of the palms on each tier alternate, while each tier of palms is elevated above the previous one. Note that, according to this approach, a leaf ball is typically higher than an adjacent palm on the next lower tier, and lower than an adjacent palm on the next higher tier. However, the leaf ball heights are nevertheless considered to be “alternated” in these embodiments, because for each leaf ball, all of the adjacent leaf balls, both on the same tier and on adjacent tiers are either higher or lower, such that each leaf ball overlaps with all of its adjacent neighbors.

In some terraced embodiments, the roots of each palm will grow outward to the edge of its terrace in one direction, while spreading unrestricted to the sides and inward.

It will be noted that, in a terraced arrangement, the palms that are “adjacent” to a given palm that is not at a boundary of the grove are the palms on the same terrace to either side of the given palm, the closest one or two palms on the next higher terrace, and the closest one or two palms on the next lower terrace. In these embodiments, the adjacent palms need not be equidistant from the given palm.

Embodiments of this terraced approach have the advantage of allowing all of the palms to receive approximately the same amount of direct sunlight per day, especially if the tiers of palms extend approximately in a north-south direction.

The present invention is a method of growing coconuts. The method includes selecting at least one variety of coconut palm to be planted, preparing at least 30 planting locations in a field, in each of the planting locations, planting a coconut palm of one of the selected varieties, and allowing the planted coconut palms to mature to form a grove of coconut palms, each of the mature coconut palms comprising a trunk and a leaf ball extending outward from a top of the trunk. As a result of the selecting of the at least one variety of coconut palm and the preparing of the at least 30 planting locations, the leaf ball of each of the mature coconut palms is either higher above grade or lower above grade than the leaf balls of all adjacent coconut palms in the grove, and the leaf ball of each of the mature coconut palms overlaps with the leaf balls of all adjacent coconut palms in the grove without substantial contact or interference therebetween.

In some embodiments, selecting the at least one variety of coconut palm comprises selecting two varieties of coconut palm which, when mature, have different lengths. In some of these embodiments, the leaf ball of each of the mature coconut palms is either higher above grade or lower above grade than the leaf balls of all adjacent coconut palms in the grove exclusively due to selection and alternation in the grove of two varieties of coconut palm. In other embodiments only one variety of coconut palm is selected, and the leaf ball of each of the mature coconut palms is either higher above grade or lower above grade than the leaf balls of all adjacent coconut palms in the grove exclusively due to preparing the planting locations at different elevations above sea level. In still other embodiments, the leaf ball of each of the mature coconut palms is either higher above grade or lower above grade than the leaf balls of all adjacent coconut palms in the grove due in part to selection and alternation in the grove of two varieties of coconut palm, and in part due to preparing the planting locations at different elevations above sea level.

In any of the above embodiments, preparing the at least 30 planting locations in the field can include preparing the planting locations at different elevations above sea level, thereby causing or accentuating the height differences above grade of the leaf balls of the adjacent palms of the plurality of coconut palms.

In any of the above embodiments, preparing the at least 30 planting locations in the field can include preparing the planting locations in a checkerboard pattern in which, after allowing the planted coconut palms to mature, the heights of the leaf balls alternate in aligned rows and columns of the coconut palms, each of the coconut palms being surrounded by four adjacent palms, or preparing the at least 30 planting locations in the field can include preparing the planting locations in a staggered hexagonal pattern, such that after allowing the planted coconut palms to mature, each of the coconut palms is surrounded by three adjacent palms.

In any of the above embodiments, after allowing the planted coconut palms to mature, the grove can include a first plurality of the palms for which their leaf balls are at a first height above grade, and a second plurality of palms for which their leaf balls are as a second height above grade that is lower than the first height, whereby for each of the palms of the first plurality that is not at an edge of the grove, all of its adjacent palms are palms of the second plurality, and vice versa.

In any of the above embodiments, for all of the palms in the grove, a diameter of the leaf ball can be approximately 20 feet and the distance between the trunks of the adjacent palms can be between 10 and 16 feet.

In any of the above embodiments, the field can be substantially uniform in elevation above sea level, except for any alternation of the elevations of the individual planting locations. Or, preparing the planting locations can include preparing a plurality of substantially horizontal tiers that are progressively greater in height above sea level from a lowest tier to a highest tier, and preparing the planting locations in successive rows on the tiers, wherein, after the palms have matured, for each given one of the palms that is not at an edge of the grove, the palms that are adjacent to the given palm are the palms on either side of the given palm that are planted on the same tier as the given palm, the closest one or two palms on the next higher tier, and the closest one or two palms on the next lower tier, the leaf ball of the given palm is either higher or lower above grade than the leaf balls of the adjacent palms that are on either side of the given palm on the same tier, the leaf ball of the given palm is lower in height above grade than the adjacent palm on the next higher tier, and the leaf ball of the given palm is higher above grade than the adjacent palm on the next lower tier. In some of these embodiments, the lowest tier is a first tier, the highest tier is an apex tier, and the tiers are progressively greater in elevation above sea level from the first tier to the apex tier, and progressively lower in height above sea level from the apex tier to a second tier. In any of these embodiments, the tiers can extend substantially in a north-south direction, such that the leaf balls of all of the coconut palms in the grove are exposed in at least one of an easterly direction and a westerly direction.

In any of the above embodiments, planting or otherwise introducing any other vegetation into the grove, except for the palms that are planted in the planting locations, can be excluded.

And in any of the above embodiments, preparing the at least 30 planting locations can include preparing at least 100 planting locations.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a palm grove of the prior art, in which palms are all of the same variety and height, and are spaced apart by approximately 20 feet;

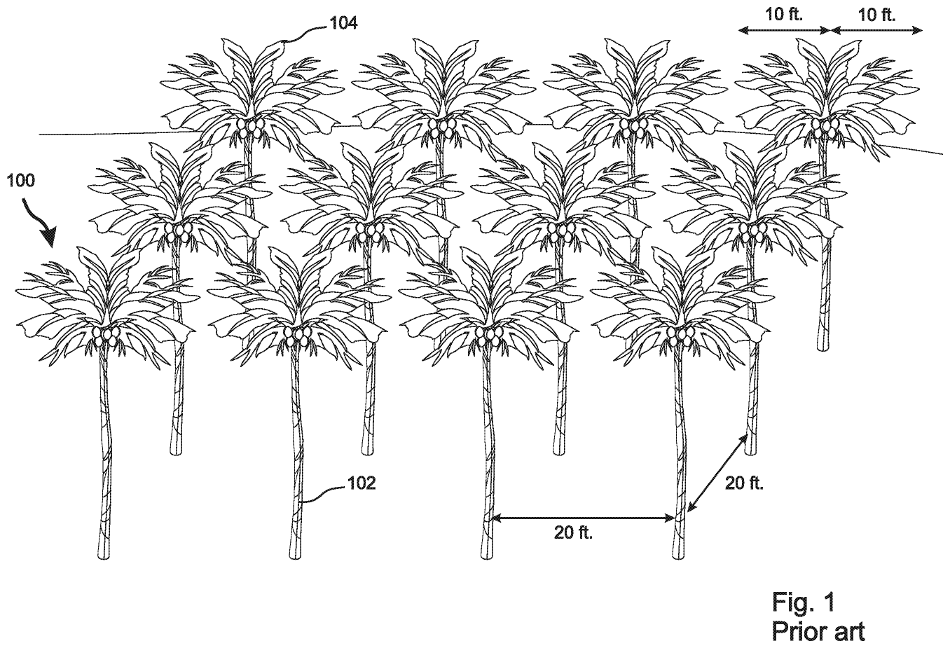

FIG. 2A is a flow diagram that illustrates embodiments of the present invention;

FIG. 2B is a side view of a single row of palms in an embodiment of the present invention in which the variety of the palms is alternated between a tall variety and a short variety, the palms being spaced apart by approximately 16 feet;

FIG. 3 is a perspective view of a grove of palms in an embodiment of the present invention in which the variety of the palms is alternated between a tall variety and a short variety, the palms being arranged in a checkerboard pattern of rows and columns and being spaced apart by approximately 16 feet;

FIG. 4A is a top view of the grove of FIG. 3, the leaf balls being represented as circles for simplicity of illustration;

FIG. 4B is a top view of a grove in an embodiment where the palms of alternating height are arranged hexagonally and spaced apart by approximately 12 feet, the leaf balls being represented as circles for simplicity of illustration;

FIG. 5A is a perspective view of a single row of palms according to an embodiment in which the elevation above grade of the planting locations is alternated by building up the ground at every other planting location;

FIG. 5B is a perspective view of a single row of palms according to an embodiment in which the elevation above grade of the planting locations is alternated by excavating the ground at every other planting location;

FIG. 6 is a side view of a single row of palms in an embodiment of the present invention in which the palms are arranged in terraced rows, the palms in each row being alternated in height, while the heights of successive terraces increase to a maximum, and then decrease again;

FIG. 7 is a perspective view of an embodiment similar to FIG. 6, illustrating the morning exposure of the palm grove to sunlight; and

FIG. 8 is a perspective view of an embodiment similar to FIG. 6, where the palms are configured in a combined checkerboard and terraced arrangement, the leaf balls being represented as spheres for ease of illustration.

### DETAILED DESCRIPTION

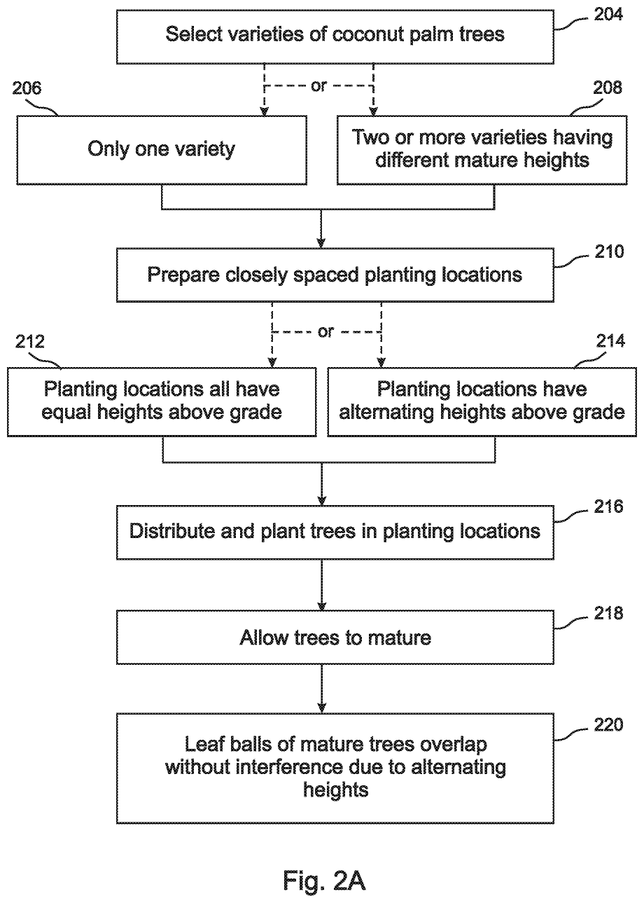

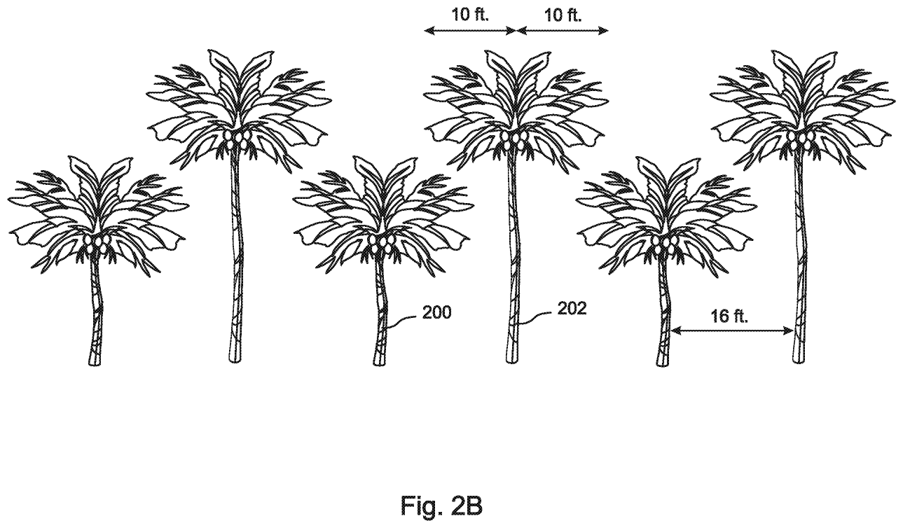

The present invention is a method of growing coconuts that provides an increased yield of coconuts per acre of land. With reference to FIG. 2A, the method includes selecting at least one variety of coconut palm to be planted 204, preparing closely spaced planting locations in a field 210, distributing and planting the coconut palms in the planting locations 216, and allowing the palms to mature 218. In embodiments, the resulting grove of coconut palms comprises at least 30 coconut palms, and can comprise 100 or more coconut palms.

Selecting the varieties of coconut palm trees 204 can include selecting only one variety of palm 206, or selecting two or more varieties of palms having different heights when mature 208. The planting locations can be prepared 210 such that they are all at the same height above grade 212, or they are at alternating heights above grade 214.

According to the present invention, when the coconut palms are mature, the heights of their leaf balls alternate above grade, where the term “grade,” as used herein, refers to an average height of the field above sea level, and the term “alternate” means that for each given one of the leaf balls, the leaf balls of all of the adjacent palms are either higher or lower than the leaf ball of the given palm, thereby allowing the leaf balls of adjacent palms to overlap.

As used herein, the palms that are “adjacent” to a given coconut palm are the palms that form a first ring of neighboring palms around the given coconut palm within the planting arrangement. The first ring need not be circular, regular, equidistant, complete, or closed. Distances between the given coconut palm and the adjacent palms can vary. In addition, for coconut palms located along a perimeter of a grove, the first ring can include fewer palms than for coconut palms located within an interior region of the grove. The “length” of a palm tree refers herein to the distance from the point at which the trunk emerges from the ground to the top of the leaf ball.

The planting locations are closely spaced, such that the leaf balls of the adjacent, mature coconut palms overlap with each other 220. Interference between adjacent leaf balls is avoided due to the differences in adjacent leaf ball heights. This allows the planting locations to be positioned much more closely together than in conventional coconut groves in which mutual interference between leaf balls having substantially the same heights limits the density of the grove and the quantity of coconuts produced per acre.

In embodiments the heights of adjacent palms are varied, at least in part, by selecting more than one variety of coconut palm 208 and by distributing 216 the palms such that the varieties are alternated. For example, with reference to FIG. 2B, the leaf balls of “dwarf” varieties 200, such as Malaysian or Fiji dwarf palms, will generally be entirely beneath the leaves of adjacent “tall” varieties 202, such as Solomon Islands, Rennell, or Malaysian tall palms, thereby allowing them to be alternated in rows of palms 200, 202 with a spacing of less than 20 feet, even if all of the planting locations are at the same height above grade 212.

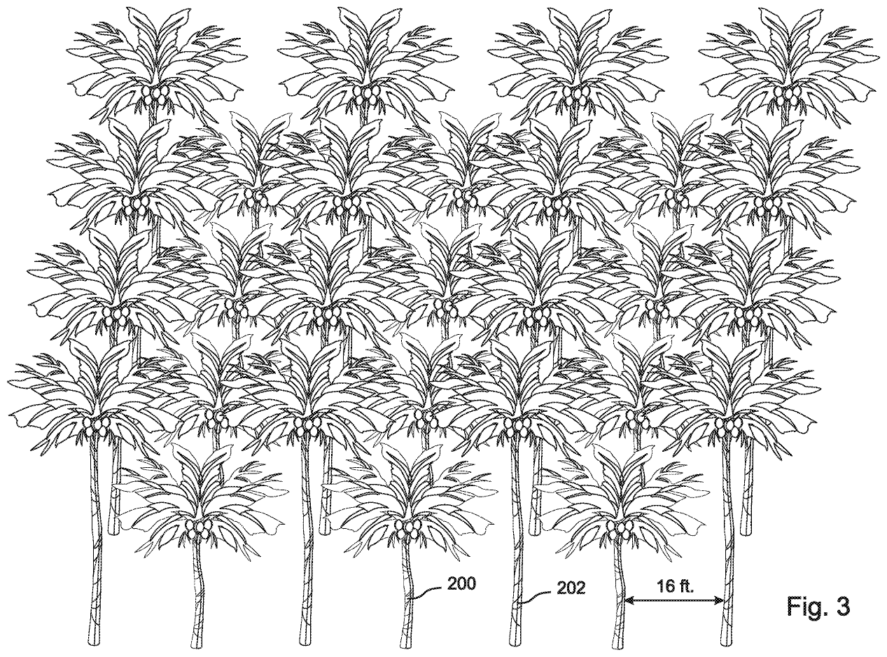

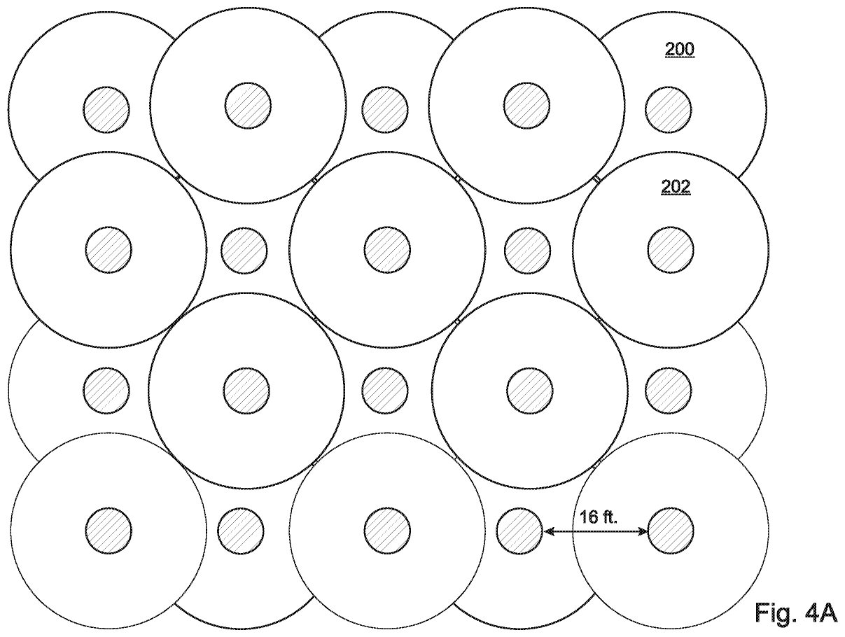

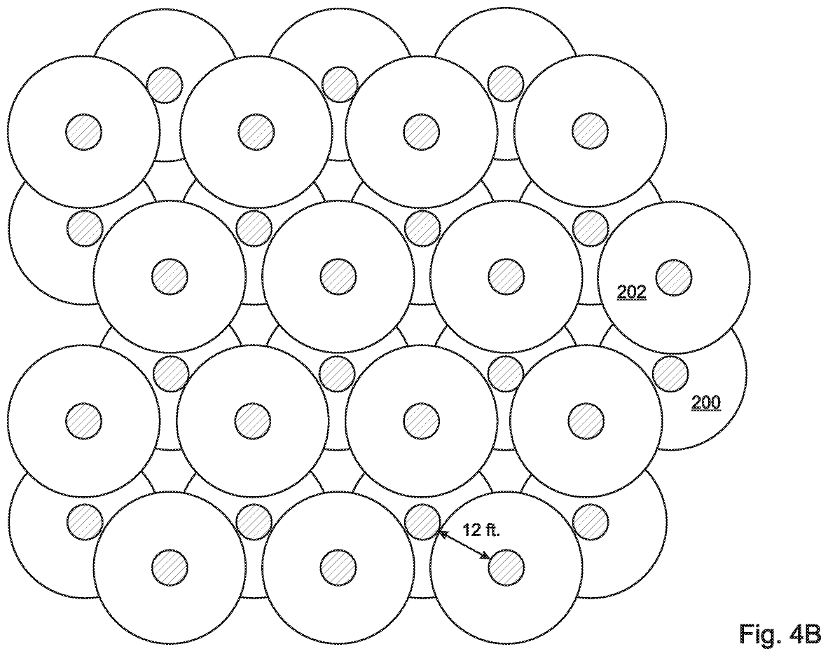

FIG. 2B illustrates a single row of palms 200, 202 in an embodiment where the palm varieties are alternated while all of the planting locations have the same height above grade. FIG. 3 is a perspective view of an entire grove of the palms 200, 202 of FIG. 2B arranged in a “checkerboard” configuration, where the heights of the leaf balls are alternated in both the rows and columns of the grove. FIG. 4A is a view from above of the grove of FIG. 3, where the leaf balls of the palms 200, 202 are indicated as circles for clarity of illustration. In this example, each of the leaf balls is at one of two heights above grade, whereby a first plurality of palms 202 having leaf balls at a first height are interspersed with a second plurality of palms 200 having leaf balls at a second height which is lower than the first height. It can be seen in FIG. 4A that each of the first plurality of palms 202 is surrounded by, and overlaps with, four “adjacent” nearest neighbor palms 200 of the second plurality, and vice versa. It will be understood that FIG. 4A would apply equally to a “checkerboard” grove in which all of the palms 200, 202 were of the same variety, and the heights above grade of the planting locations was alternated.

In the embodiments of FIG. 3 and FIG. 4A, the leaf balls are 20 feet in diameter, while the spacing between palms 200, 202 is reduced from 20 feet to approximately 16 feet, thereby increasing the yield per acre by approximately 50%.

FIG. 4B is a top view similar to FIG. 4A of an embodiment in which the palms are arranged in staggered rows, forming a “hexagonal” pattern of palms 200. As in FIG. 4A, a first plurality of palms 202 having leaf balls at a first height are interspersed with a second plurality of palms 200 having leaf balls at a second height which is lower than the first height. It can be seen in FIG. 4B that each of the first plurality of palms 202 is surrounded by, and overlaps with, three “adjacent” nearest neighbor palms 200 of the second plurality, and vice versa. In embodiments that implement this hexagonal arrangement of the coconut palms 200, 202, the leaf balls can overlap to an extent that enables the leaf balls of the “shorter” first plurality 200 to nearly touch the trunks of the taller palms of the second plurality 202. In FIG. 4B, the leaf balls are 20 feet in diameter, and the trunks of adjacent palms 200, 202 are separated by only 12 feet. As a result, the yield per acre is nearly quadrupled.

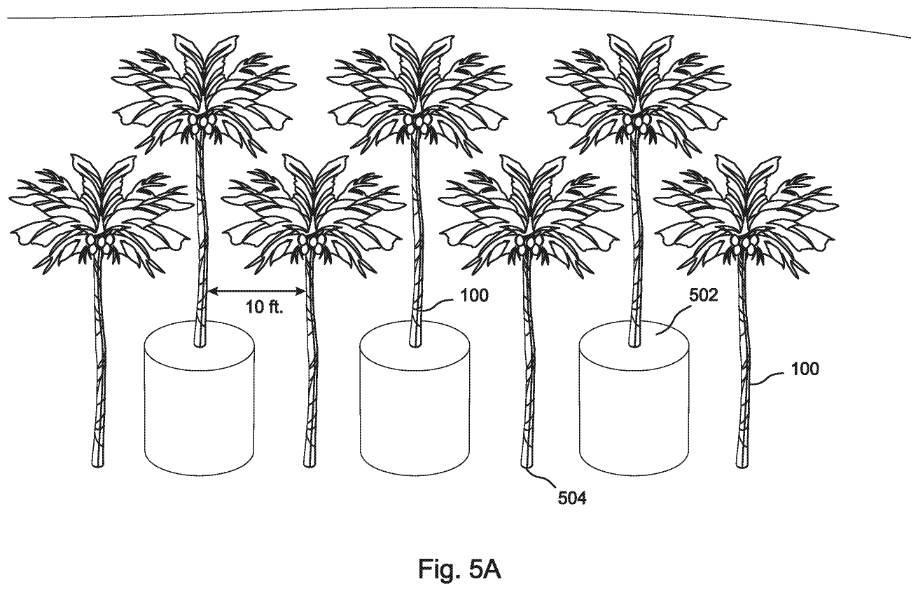

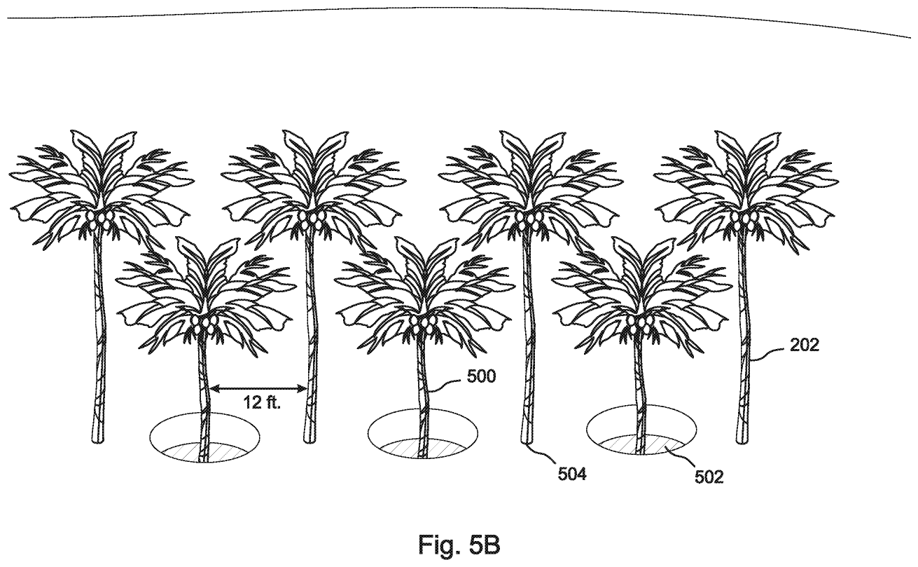

In embodiments where all of the planting locations are at the same height 212, the alternation of the heights of the leaf balls is provided entirely by interspersing a shorter variety of coconut palms with a taller variety of coconut palm. With reference to FIGS. 5A and 5B, in other embodiments the heights of the leaf balls of the palms 100 are varied, at least in part, by adjusting the heights of the planting locations 502, 504. This approach can be applied to a grove that includes only one variety 206 of palm 100, or it can be used to further enhance the height differences between the leaf balls of adjacent palms 100, 500 of different varieties 208.

For example, in the embodiment of FIG. 5A, the leaf balls of the palms are approximately 20 feet in diameter and about 5-6 feet in height, including the crowns. Interference between the leaf balls of adjacent palms 100 of the same variety is avoided by raising the planting location 502 of every other palm 100 by about 6 feet, while the other planting locations 504 remain at grade. Similarly, in the embodiment of FIG. 5B, interference between the leaf balls of adjacent palms 100 of the same variety is avoided by lowering the planting location 502 of every other palm 100 by about 6 feet, while the other planting locations 504 remain at grade. It will be understood that the approaches of FIGS. 5A and 5B can be combined. For example, every other palm 100 can be raised or lowered by approximately 3 feet, creating height differences of 6 feet.

While the coconut palms 100 of FIG. 5A are all of the same variety, it will be clear that varying the elevations of the planting locations can enable overlap without interference between the leaf balls of palms of different varieties. For example, by adjusting the elevations of the planting locations, the leaf balls of palms of a tall variety 202 can be made to fully overlap the leaf balls of adjacent hybrid palms having an intermediate height between the tall 202 and dwarf 200 palm varieties. With continuing reference to FIG. 5B, if the leaf balls are all 20 feet in diameter and approximately spherical, the difference in heights between the tall and hybrid varieties is 11 feet, the palms are planted with a spacing of 12 feet, and every other palm 500 in a row is a hybrid palm planted in a recessed location 502 that has been excavated to a level that is about six feet below the planting locations 504 of adjacent “tall” varieties 202, interference between the leaves of adjacent palms 202, 500 can be avoided, while at the same time causing the roots of the hybrid palms 500 to extend at a depth that is well below the roots of the tall palms 202.

Coconut palms are generally grown in areas of intense sunlight. Accordingly, with reference again to FIGS. 4A and 4B, in some embodiments where the palms are planted in a “checkerboard” or “hexagonal” pattern, with the heights of the palms 200, 202 being alternated in each row and also between adjacent rows, the palms having their leaf balls at the lower heights 200 receive sufficient sunlight to meet their needs, even though they receive direct sunlight only during a limited duration near the middle of each day when the sun is approximately overhead, while receiving less light at other times of day due to being in the partial “shadow” of the adjacent, higher palms 202. If the palms 202 having leaf balls at the greater height are of a variety that is more resistant to intense light and heat, this may even help to protect the other palms 200 from over exposure to the sun.

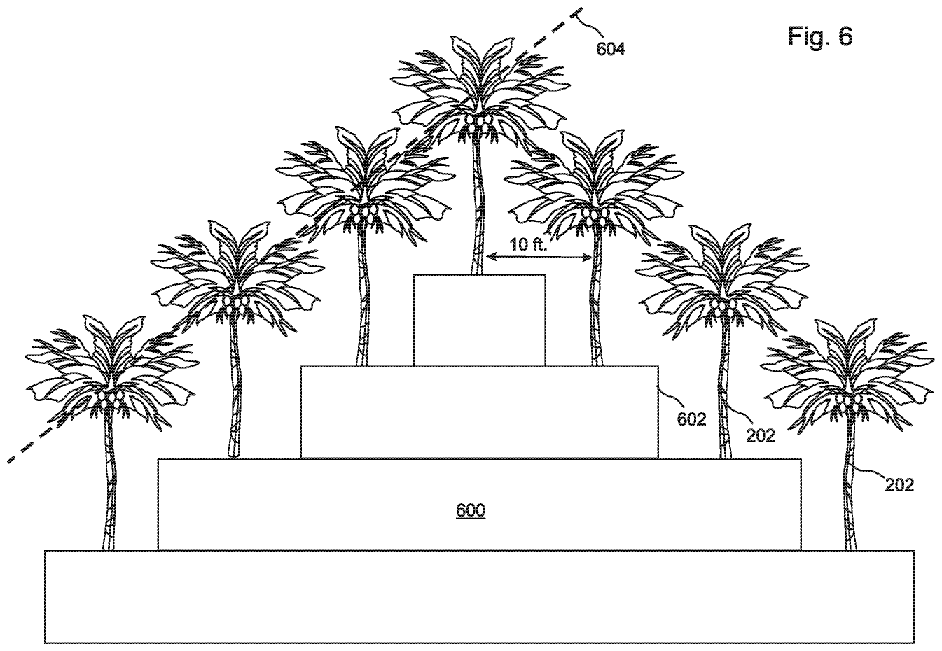

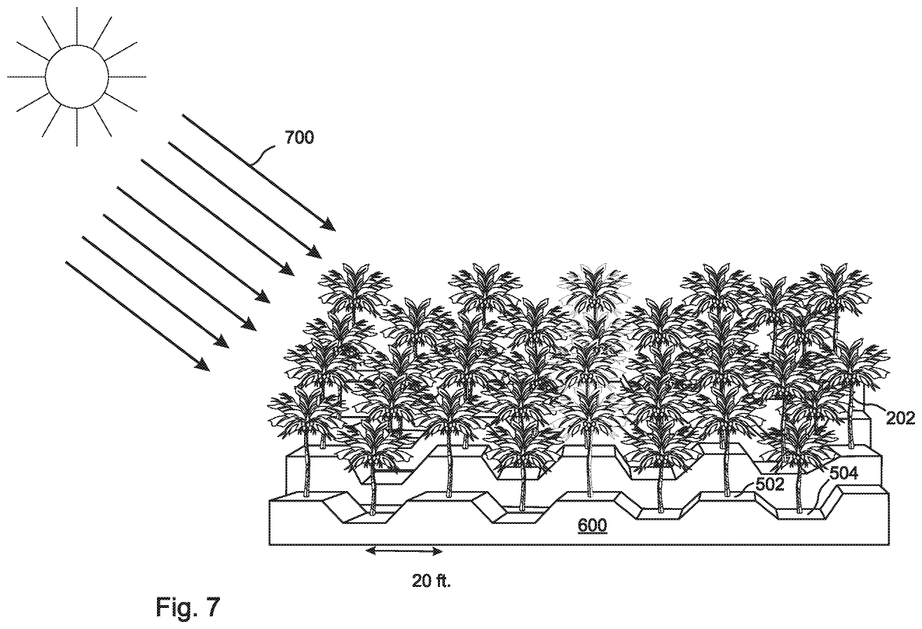

With reference to FIGS. 6 and 7, in other embodiments the planting locations are prepared as “terraces” by excavating “tiers” 600 into a hillside or similar terrain. According to this approach, as can be seen in FIG. 7, the heights of the palms 202 on each tier 600 alternate, while each tier 600 of palms is elevated in height above the previous one. Note that, according to this approach, each leaf ball is typically higher than the leaf ball of an adjacent palm on the next lower tier, and lower than the leaf ball of an adjacent palm on the next higher tier. However, the leaf ball heights are nevertheless considered to be “alternated” in these embodiments, because for each leaf ball, all of the adjacent leaf balls are either higher or lower, such that each leaf ball overlaps with all of its adjacent neighbors.

It can be seen in FIG. 7 that the palms are aligned between adjacent tiers, such that the palms that are “adjacent” to a given palm that is not at a boundary of the grove are the palms on the same terrace to either side of the given palm, the closest palm on the next higher terrace, and the closest palm on the next lower terrace. In similar embodiments where the palms are staggered between adjacent tiers, the palms that are “adjacent” to a given palm that is not at a boundary of the grove are the palms on the same terrace to either side of the given palm, the two closest palms on the next higher terrace, and the two closest palms on the next lower terrace. In these terraced embodiments, the adjacent palms need not be equidistant from the given palm.

In some of these terraced embodiments, the roots of each palm 202 will grow outward to the edge 602 of its terrace 600 in one direction, while spreading unrestricted to the sides and inward in the other direction. The terracing thereby ensures that the roots from adjacent terraces do not interfere with each other. The terraced approach of FIGS. 6-7 can have the advantages of nearly doubling the yield per acre, while causing all of the palms 202, 500 to receive approximately the same amount of direct sunlight 700 per day, especially when the terraces 600 extend approximately in a north-south direction.

The effect of “terracing” the palms, as illustrated in FIG. 6, is essentially to arrange the leaf balls in a tilted plane 604. In the example of FIG. 6, the leaf balls are approximately spherical, and are separated from each other in the tilted plane 604 by approximately 20 feet. However, due to the “tilt” of the plane 604, the horizontal spacing between the trunks in the “terraced” direction is much less than 20 feet.

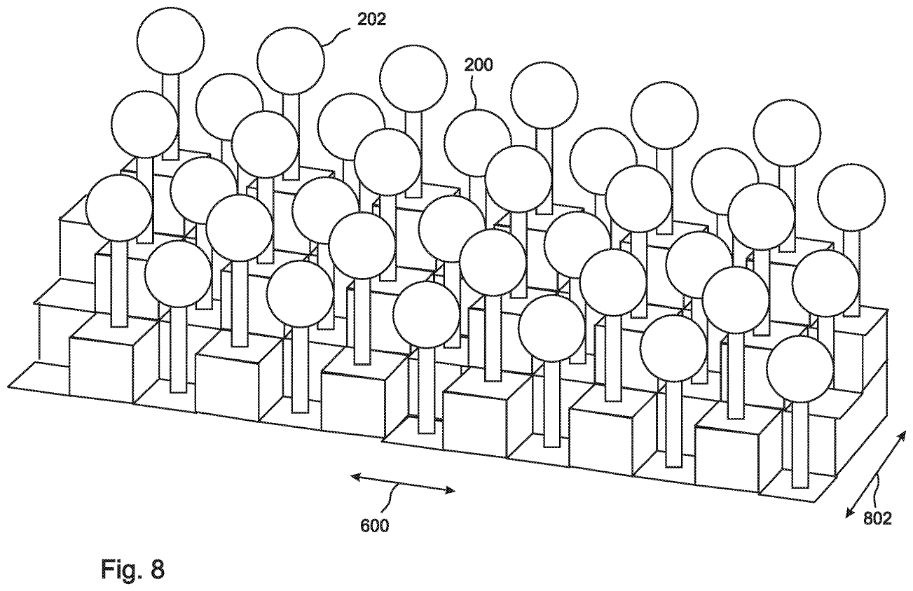

FIG. 8 is a simplified illustration of the embodiment of FIG. 7. It can be seen that the heights of the leaf balls alternate along each tier 600, while successively increasing in the terraced direction 802, thereby tilting the “plane” 604 of the leaf balls 202, and enabling the spacing between the trunks of the palms 202 to be reduced. In some embodiments, depending on the relative heights above grade of adjacent tiers, the horizontal spacing between the trunks can be reduced to less than 10 feet in the terraced direction 802.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A method of growing coconuts comprising:
selecting at least one variety of coconut palm to be planted;
preparing at least 30 planting locations in a field;
in each of the planting locations, planting a coconut palm of one of the selected varieties; and
allowing the planted coconut palms to mature to form a grove of coconut palms, each of the mature coconut palms comprising a trunk and a leaf ball extending outward from a top of the trunk;
wherein as a result of the selecting of the at least one variety of coconut palm and the preparing of the at least 30 planting locations:
the leaf ball of each of the mature coconut palms is either higher above grade or lower above grade than the leaf balls of all adjacent coconut palms in the grove; and
the leaf ball of each of the mature coconut palms overlaps with the leaf balls of all adjacent coconut palms in the grove without substantial contact or interference therebetween.

2. The method of claim 1, wherein selecting the at least one variety of coconut palm comprises selecting two varieties of coconut palm which, when mature, have different lengths.

3. The method of claim 1, wherein preparing the at least 30 planting locations in the field comprises preparing the planting locations at different elevations above sea level, thereby causing or accentuating the height differences above grade of the leaf balls of the adjacent palms of the plurality of coconut palms.

4. The method of claim 1, wherein the leaf ball of each of the mature coconut palms is either higher above grade or lower above grade than the leaf balls of all adjacent coconut palms in the grove exclusively due to selection and alternation in the grove of two varieties of coconut palm.

5. The method of claim 1, wherein only one variety of coconut palm is selected, and wherein the leaf ball of each of the mature coconut palms is either higher above grade or lower above grade than the leaf balls of all adjacent coconut palms in the grove exclusively due to preparing the planting locations at different elevations above sea level.

6. The method of claim 1, wherein the leaf ball of each of the mature coconut palms is either higher above grade or lower above grade than the leaf balls of all adjacent coconut palms in the grove due in part to selection and alternation in the grove of two varieties of coconut palm, and in part due to preparing the planting locations at different elevations above sea level.

7. The method of claim 1, wherein preparing the at least 30 planting locations in the field comprises preparing the planting locations in a checkerboard pattern in which, after allowing the planted coconut palms to mature, the heights of the leaf balls alternate in aligned rows and columns of the coconut palms, each of the coconut palms being surrounded by four adjacent palms.

8. The method of claim 1, wherein preparing the at least 30 planting locations in the field comprises preparing the planting locations in a staggered hexagonal pattern, such that after allowing the planted coconut palms to mature, each of the coconut palms is surrounded by three adjacent palms.

9. The method of claim 1, wherein:
after allowing the planted coconut palms to mature, the grove comprises a first plurality of the palms for which their leaf balls are at a first height above grade, and a second plurality of palms for which their leaf balls are as a second height above grade that is lower than the first height; and
for each of the palms of the first plurality that is not at an edge of the grove, all of its adjacent palms are palms of the second plurality, and vice versa.

10. The method of claim 1, wherein for all of the palms in the grove, a diameter of the leaf ball is approximately 20 feet and the distance between the trunks of the adjacent palms is between 10 and 16 feet.

11. The method of claim 1, wherein the field is substantially uniform in elevation above sea level, except for any alternation of the elevations of the individual planting locations.

12. The method of claim 1, wherein:
preparing the planting locations comprises:
preparing a plurality of substantially horizontal tiers that are progressively greater in height above sea level from a lowest tier to a highest tier; and
preparing the planting locations in successive rows on the tiers;
wherein, after the palms have matured, for each given one of the palms that is not at an edge of the grove;
the palms that are adjacent to the given palm are the palms on either side of the given palm that are planted on the same tier as the given palm, the closest one or two palms on the next higher tier, and the closest one or two palms on the next lower tier;
the leaf ball of the given palm is either higher or lower above grade than the leaf balls of the adjacent palms that are on either side of the given palm on the same tier;
the leaf ball of the given palm is lower in height above grade than the adjacent palm on the next higher tier; and
the leaf ball of the given palm is higher above grade than the adjacent palm on the next lower tier.

13. The method of claim 12, wherein the lowest tier is a first tier, the highest tier is an apex tier, and the tiers are progressively greater in elevation above sea level from the first tier to the apex tier, and progressively lower in height above sea level from the apex tier to a second tier.

14. The method of claim 12, wherein the tiers extend substantially in a north-south direction, such that the leaf balls of all of the coconut palms in the grove are exposed in at least one of an easterly direction and a westerly direction.

15. The method of claim 1, wherein the method does not include planting or otherwise introducing any other vegetation into the grove, except for the palms that are planted in the planting locations.

16. The method of claim 1, wherein preparing the at least 30 planting locations comprises preparing at least 100 planting locations.
